(19) United States
(12) Patent Application Publication
(10) Pub. No.: US 2024/0202325 A1
(43) Pub. Date: Jun. 20, 2024

(54) System and Method for Explainable Anomaly Detection

(71) Applicant: Mitsubishi ElectricResearch Laboratories, Inc., Cambridge, MA (US)

(72) Inventors: Kyeong Jin Kim, Lexington, MA (US); Aolin Ding, McClean, VA (US); Ye Wang, Andover, MA (US); Koike Akino Toshiaki, Cambridge, MA (US); Kieran Parsons, Cambridge, MA (US)

(21) Appl. No.: 18/068,537

(22) Filed: Dec. 20, 2022

(51) Int. Cl. G06F 21/55

(52) U.S. Cl. CPC G06F 21/554; G06F 2221/033

(57) ABSTRACT

The present disclosure provides an anomaly detector. The anomaly detector comprises an input interface configured to accept input data, a first neural network having an autoencoder architecture including an encoder trained to encode the input data and a decoder trained to decode the encoded input data to reconstruct the input data, and a loss estimator configured to compare a plurality of parts of the input data with corresponding plurality of parts of the reconstructed input data to determine a sequence of losses for different components of a reconstruction error. The anomaly detector further comprises a second neural network trained in a supervised manner to classify the sequence of losses to detect an anomaly to produce a result of anomaly detection including one or a combination of a type of the anomaly and a severity of the anomaly, and an output interface to render the result of anomaly detection.

### TECHNICAL FIELD

The present disclosure generally relates to anomaly detection and more specifically to a system and a method for explainable anomaly detection using a neural network architecture.

### BACKGROUND

Anomaly detection generally involves a task of detecting anomalous situations. This task is broadly applicable to various applications such as security, safety, quality control, failure monitoring, process control, etc. Across various applications, an objective of the anomaly detection is typically to raise an alarm about unusual situations that require further investigation and potentially responsive action to mitigate any deleterious issues. Due to huge information flow, manual investigation and response can be costly. Thus, it is desired for an anomaly detector to provide information that helps to explain reasons for the detected anomaly, in order to guide the investigation and the responsive action.

Generally, the anomaly detectors use autoencoders that reconstruct input data and a reconstruction loss between the input data and the reconstructed data is used to detect anomalies in the input data. One of the major problems in training the anomaly detectors is the lack of training data having the anomaly. Hence, the autoencoders configured to detect the anomaly are currently trained based on normal non-anomalous data. The concept of training the autoencoder on only the normal non-anomalous data is called one-class learning, where the one-class learning models data distribution of “normal” (non-anomalous) data samples. In the one-class learning, the reconstruction loss of the autoencoder acts as an indicator of whether an input data example (given at test time) is anomalous or not. For example, if the reconstruction loss is greater than a threshold, then it is inferred that the input data is anomalous. The autoencoder trained according to the one-class learning is referred to as one-class classifier.

However, the one-class classifier may fail to properly handle rich context of real-world practical applications, wherein the input data used includes multiple and possible heterogeneous features. Accordingly, there is a need for an anomaly detector that analyzes each feature of the input data to detect an anomaly and/or provides information explaining the reason for the detected anomaly.

### SUMMARY

It is an object of some embodiments to provide an anomaly detector that not only detects an anomaly, but also explains the detected anomaly, e.g., determines a type of anomaly and a severity of anomaly. It is also an object of some embodiments to provide a multi-stage training method for training a neural network for the anomaly detection. Additionally or alternatively, it an object of some embodiments to adapt a neural network trained on data of one domain, to another domain.

The anomaly detectors use autoencoder including an encoder and a decoder, for the anomaly detection. The autoencoder can be trained with data samples for the anomaly detection. Some embodiments are based on recognition that, in practice, a large set of normal data samples may be available, however, sufficient amounts of anomalous data samples may not be available as it is difficult to list all kinds of possible anomalous samples. Therefore, the anomaly detection is an unsupervised learning problem which does not rely on prior information, in other words, assumes that all data samples are unlabeled.

To that end, during a first training stage of the multi-stage training, the autoencoder is trained with unlabeled data samples in an unsupervised learning manner. In particular, the autoencoder is trained on the unlabeled data samples to learn their representations and use these representations to reconstruct the unlabeled data samples. In an embodiment, the unlabeled data samples are structured proxy data samples that include a mixture of different types of features including but may not limit to character features, categorical features and numerical features. Therefore, different embedding methods are used to process the different features. For example, the encoder of the autoencoder embeds the character features with truncating and padding processes. Meanwhile, the encoder embeds the numerical and categorical features separately and expands across dimensions to adapt to the same size of the character features. Further, for decoder topology, convolutional decoder networks are constructed symmetrically using convolutional layers, max-pooling layers, skip connection modules and fully connected layers.

The reconstructed unlabeled data samples are compared with the unlabeled data samples to determine corresponding reconstruction losses. Since the unlabeled data samples include the different types of features, different loss functions are utilized for determining reconstruction losses of the different types of features. For example, in an embodiment, a cross-entropy loss function is used for the character features and the categorical features and mean square error (MSE) loss function is used for the numerical features. Further, a total loss is calculated as a sum of all the reconstruction losses of the different the types of features multiplied by their weights. The total loss is used for back propagation and updating the autoencoder during training of the autoencoder.

Additionally, in an embodiment, to achieve the best performance of the autoencoder, a hyperparameter optimization framework is employed to tune hyperparameter settings (e.g., learning rate) and partial network structures (e.g., channel size of convolutional layers) in extensive trials. An objective of the hyperparameter optimization framework is to maximize testing accuracy when testing the trained autoencoder on new anomaly detection datasets, which helps to determine the best topology and hyperparameter settings for the autoencoder.

Further, during a second training stage of the multi-stage training, a model stacking is conducted by replacing weighted sum calculation of the total loss of the autoencoder with a classification model. In particular, the autoencoder trained according to the first training stage is stacked with the classification model to take all different loss terms (i.e., the reconstruction losses of the different types of features) as inputs and predict a class of the anomaly as an output. The classification model is constructed using logistic regression (LR) network or multilayer perceptron (MLP) network. During the second training stage, a combination of the autoencoder trained according to the first training stage and the classification model, is trained with labeled data samples in a supervised learning manner.

During the second training stage, partial networks may be freezed to achieve the best performance on testing datasets and strengthen robustness of entire model (i.e., the autoencoder and the classification model). For instance, the encoder and the decoder of the autoencoder may be freezed and only the classification model is trained with the labeled data samples.

In an embodiment, the unlabeled data samples and the labeled data samples may be of same domain. Thus, the autoencoder and/or the classification model trained with the unlabeled data samples and the labeled data samples has limited generality towards new attacks and cannot adapt to new domains even with similar distributions. To that end, some embodiments aim to adopt the autoencoder and the classification model trained according to the second training stage to a new domain. Such a domain adaptation is achieved by executing a third training stage.

During the third training stage, the autoencoder and the classification model trained according to the second training stage are trained with labeled samples of a new domain, in a supervised learning manner. The new domain is different from the domain of the unlabeled data samples and the labeled data samples. During the third training stage, a learning rate smaller than a learning rate used in the second training stage is leveraged to slightly change classification boundary of the classification model to fit new attack samples without reducing testing accuracy on previously trained datasets (i.e., the unlabeled data samples and the labeled data samples). Such a domain adaptation is applied for multiple times to identify different but related anomalies, which has potential to detect even unseen anomalies.

In some embodiments, partial networks may be freezed during the third training stage. For example, the encoder and the decoder of the autoencoder may be freezed and only the classification model is trained with the labeled samples of the new domain. In another example, only the encoder is freezed, and the decoder and the classification model are trained with the labeled samples of the new domain.

To that end, the multi-stage training yields a neural network architecture trained for anomaly detection, wherein the neural network architecture includes the trained autoencoder and the classification model. During real-time operation, input data/test sample is provided to the autoencoder. The autoencoder includes the encoder trained to encode the input data and the decoder trained to decode the encoded input data to reconstruct the input data. Further, a loss estimator compares a plurality of parts of the input data with corresponding plurality of parts of the reconstructed input data to determine a sequence of losses for different components of a reconstruction error. Furthermore, the classification model trained in the supervised manner classifies the sequence of losses to detect an anomaly to produce a result of anomaly detection including one or a combination of a type of the anomaly and a severity of the anomaly.

Accordingly, one of the embodiments discloses an anomaly detector that comprises at least one processor, and memory having instructions stored thereon that form modules of the anomaly detector, where the at least one processor is configured to execute the instructions of the modules of the anomaly detector. The modules comprise an input interface configured to accept input data, a first neural network having an autoencoder architecture that comprises an encoder trained to encode the input data and a decoder trained to decode the encoded input data to reconstruct the input data. The modules further comprise a loss estimator configured to compare a plurality of parts of the input data with corresponding plurality of parts of the reconstructed input data to determine a sequence of losses for different components of a reconstruction error. The modules further comprise a second neural network trained in a supervised manner to classify the sequence of losses to detect an anomaly to produce a result of anomaly detection including one or a combination of a type of the anomaly and a severity of the anomaly. The anomaly detector further comprises an output interface configured to render a result of the anomaly detection.

Accordingly, one of the embodiments discloses a method for detecting an anomaly. The method comprises receiving input data, encoding the input data and decoding the encoded input data to reconstruct the input data, based on a first neural network having an autoencoder architecture. The method further comprises determining a sequence of losses by comparing a plurality of parts of the input data with corresponding plurality of parts of the reconstructed input data; classifying, based on a second neural network trained in a supervised manner, the sequence of losses to detect an anomaly to produce a result of anomaly detection including one or a combination of a type of the anomaly and a severity of the anomaly; and rendering a result of the anomaly detection.

Accordingly, one of the embodiments discloses a non-transitory computer readable storage medium embodied thereon a program executable by a processor for performing a method for anomaly detection. The method comprises receiving input data, encoding the input data and decoding the encoded input data to reconstruct the input data, based on a first neural network having an autoencoder architecture. The method further comprises determining a sequence of losses by comparing a plurality of parts of the input data with corresponding plurality of parts of the reconstructed input data; classifying, based on a second neural network trained in a supervised manner, the sequence of losses to detect an anomaly to produce a result of anomaly detection including one or a combination of a type of the anomaly and a severity of the anomaly; and rendering a result of the anomaly detection.

### BRIEF DESCRIPTION OF THE DRAWINGS

FIG. 1A illustrates an anomaly detector for anomaly detection, in accordance with an example embodiment.

FIG. 1B illustrates a functional diagram of the anomaly detector, in accordance with an example embodiment.

FIG. 2A illustrates a first training stage, in accordance with an example embodiment.

FIG. 2B illustrates a second training stage, in accordance with an example embodiment.

FIG. 2C illustrates a third training stage, in accordance with an example embodiment.

FIG. 3A illustrates an architecture of the anomalous detector including a reconstruction loss-based classifier, in accordance with an example embodiment.

FIG. 3B illustrates an architecture of the anomalous detector including an attribution-based classifier, in accordance with an example embodiment.

FIG. 4 illustrates an architecture of an explainability model of the anomaly detector, in accordance with an example embodiment.

FIG. 5A illustrates decomposition of internet proxy log data into categorical features and numerical features, in accordance with an example embodiment.

FIG. 5B illustrates a concatenation module configured to concatenate data corresponding to a plurality of features of a Uniform Resource Locator (URL), in accordance with an example embodiment.

FIG. 6 illustrates a flowchart of a method for detecting anomaly, in accordance with an example embodiment.

FIG. 7 illustrates a block diagram for detecting a cyberattack on a Substation Automation System (SAS), in accordance with an example embodiment.

FIG. 8 illustrates a block diagram for anomaly detection in video data, in accordance with an example embodiment.

FIG. 9 illustrates a block diagram of a computer-based anomaly detector for detecting anomaly, in accordance with an example embodiment.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

As used in this specification and claims, the terms “for example,” “for instance,” and “such as,” and the verbs “comprising,” “having,” “including,” and their other verb forms, when used in conjunction with a listing of one or more components or other items, are each to be construed as open ended, meaning that the listing is not to be considered as excluding other, additional components or items. The term “based on” means at least partially based on. Further, it is to be understood that the phraseology and terminology employed herein are for the purpose of the description and should not be regarded as limiting. Any heading utilized within this description is for convenience only and has no legal or limiting effect.

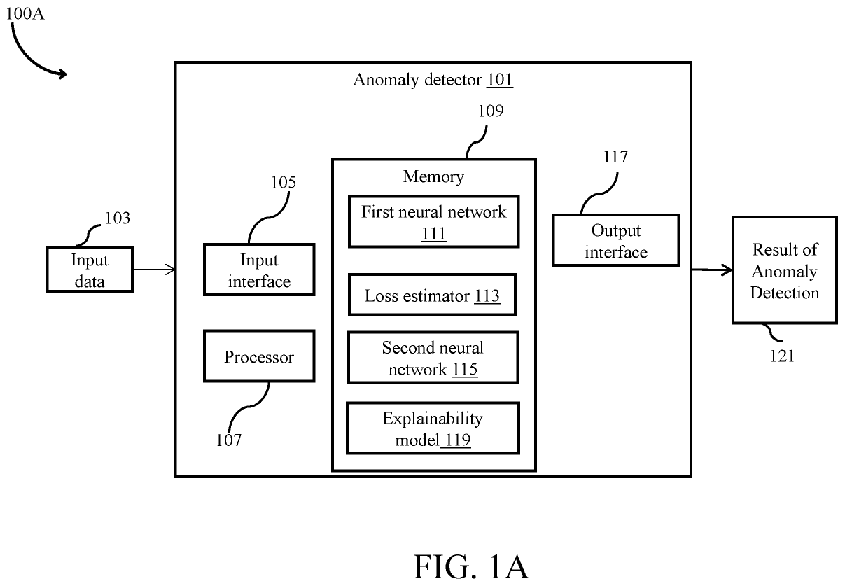

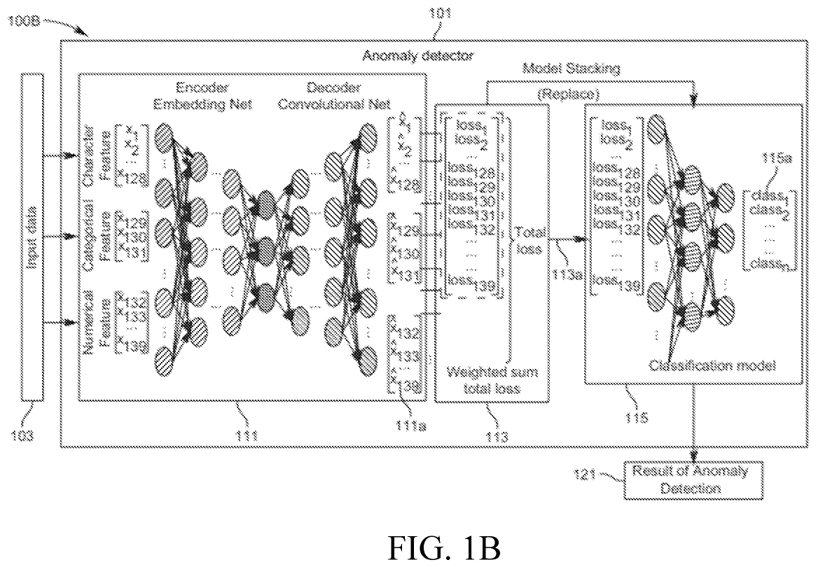

FIG. 1A illustrates a block diagram 100A of an anomaly detector 101 for anomaly detection, in accordance with an example embodiment. The anomaly detector 101 includes an input interface 105 to obtain input data 103. In addition, the anomaly detector 101 includes a processor 107, and a memory 109. Examples of the processor 107 include, but are not limited to, an application-specific integrated circuit (ASIC) processor, a reduced instruction set computing (RISC) processor, a complex instruction set computing (CISC) processor, graphical processing unit (GPU), a field-programmable gate array (FPGA), and the like.

In some embodiments, the memory 109 includes suitable logic, circuitry, and/or interfaces to store a set of computer-readable instructions for performing operations. Additionally, examples of the memory 109 may include a random-access memory (RAM), a read-only memory (ROM), a removable storage drive, a hard disk drive (HDD), and the like. It will be apparent to a person skilled in the art that the scope of the disclosure is not limited to realizing the memory 109 in the anomaly detector 101, as described herein.

The memory 109 is configured to store instructions that form modules of the anomaly detector 101. The modules comprise a first neural network 111, a loss estimator 113, a second neural network 115, and an explainability model 119. Additionally, in some embodiments, the input interface 103 and an output interface 117 are also stored in the form of modules in the memory 109. The instructions stored in the form of modules in the memory 109 are executed by the processor 107. The anomaly detector 101 is configured to process the input data 103, using the modules stored in the memory 109, to produce a result of anomaly detection 121, as described below in FIG. 1B.

FIG. 1B illustrates a functional diagram 100B of the anomaly detector 101, in accordance with an example embodiment. The anomaly detector 101 obtains the input data 103. The input data 103 may correspond to sequential data that comprises a mixture of heterogeneous features. The sequential data may include text data (such as internet proxy log data), image data, video data, audio data, and the like. In some embodiments, the input data 103 may comprise multiple features such as categorical features, numerical features, character features and the like. The input data 103 is input to the first neural network 111.

The first neural network 111 has an autoencoder architecture that comprises an encoder and a decoder. The encoder is trained to encode the input data 103 and the decoder is trained to decode the encoded input data to reconstruct the input data to produce reconstructed input data 111a. The reconstructed input data 111a is provided to the loss estimator 113. The loss estimator 113 is configured to compare a plurality of parts of the input data 103 with corresponding plurality of parts of the reconstructed input data 113a to determine a sequence of losses 113a for different components of a reconstruction error. The sequence of losses 113a corresponds to a difference between the input data 103 and the reconstructed input data 111a.

Further, the sequence of losses 113a is submitted to the second neural network 115. The second neural network 115 is trained in a supervised manner to classify the sequence of losses 113a to detect an anomaly to produce the result of anomaly detection 121. The result of anomaly detection 121 is rendered to a user via the output interface 117. The result of anomaly detection 121 includes a class of anomaly. For example, the second neural network 115 corresponds to a classification model that is configured to classify the sequence of losses 113a into a group of classes (class₁ to classₙ) 115a. Class₁ may be a ‘non-anomaly class’ which indicates that no anomaly is detected. Class₂ to classₙ may correspond to different types of anomalies. The second neural network 115 may, for example, determine that an anomaly of class₅ is detected.

In some embodiments, the second neural network 115 determines a probability of a class to which the anomaly may belong to. The probability of the class is compared with a threshold probability to determine the class of anomaly. For example, the second neural network 115 may output class₂ with a probability of 0.2, which means that anomaly of class₂ is probably present in the input data 103. If the probability of class₂ is greater than the threshold probability, then that it is inferred that the anomaly of class₂ detected.

Additionally or alternatively, the result of anomaly detection 121 includes a severity of the anomaly. Examples of the severity of anomaly may include low, medium, high, and critical. For instance, the second neural network 115 may determine an anomaly of class₂ with severity as high.

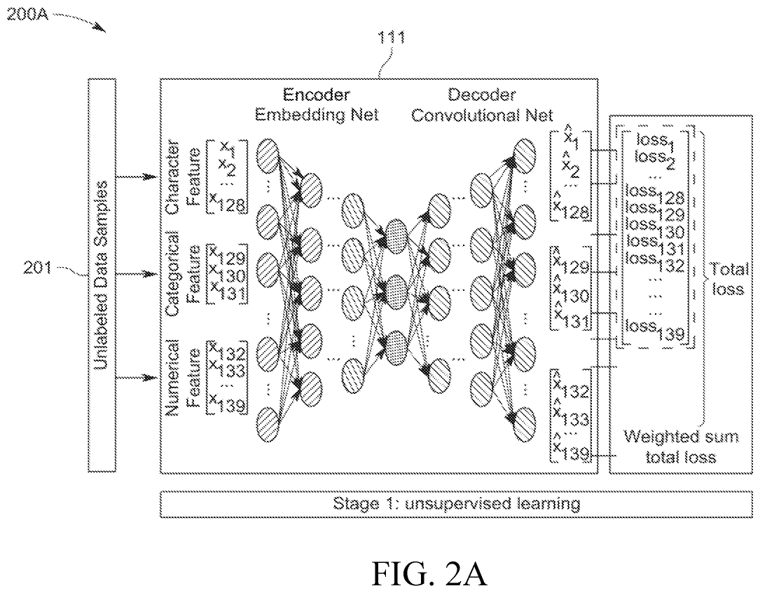

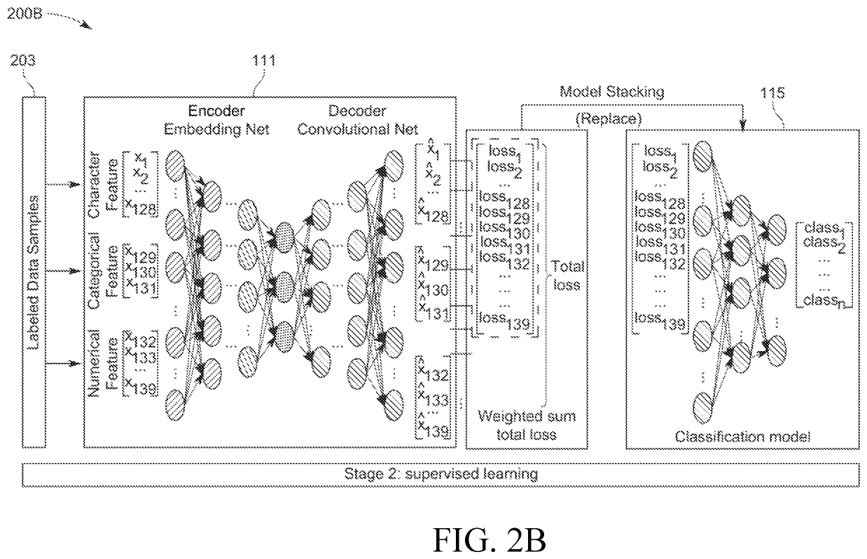

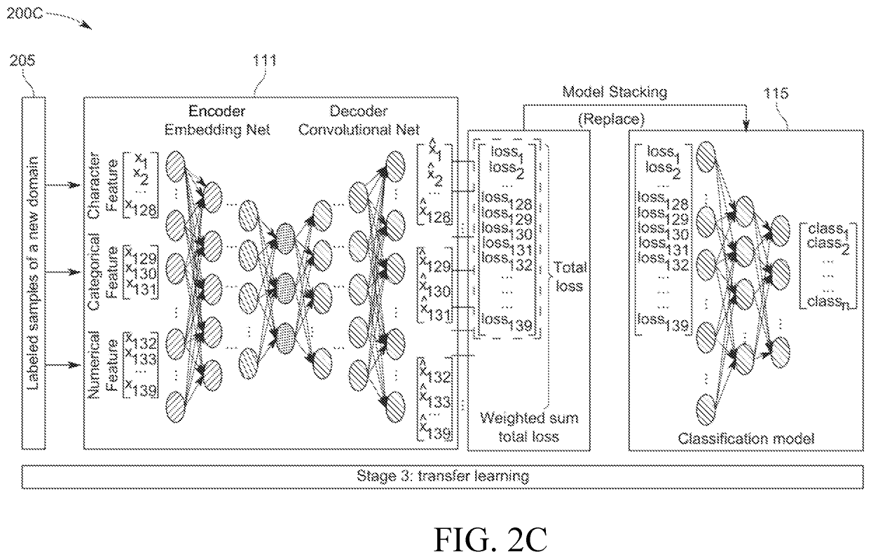

The neural network architecture (shown in FIG. 1B) including the first neural network 111 and the second neural network 115, is trained in multiple stages for anomaly detection. Each training stage is explained below in FIG. 2A, FIG. 2B, and FIG. 2C.

FIG. 2A illustrates a first training stage 200A, in accordance with an example embodiment. Some embodiments are based on recognition that, in practice, a large set of normal data samples may be available, however, sufficient amount of anomalous data samples may not be available as it is difficult to list all kinds of possible anomalous samples. Therefore, the anomaly detection is an unsupervised learning problem which does not rely on prior information, in other words, assumes that all data samples are unlabeled.

To that end, during the first training stage 200A, the first neural network 111 is trained with unlabeled data samples 201 in an unsupervised learning manner. In particular, the autoencoder comprised by the first neural network 111 is trained on the unlabeled data samples 201 to learn their dimensionality representations and use these representations to reconstruct the unlabeled data samples 201. In an embodiment, the unlabeled data samples 201 are structured proxy data samples that include a mixture of different types of features including but may not limit to character features, categorical features and numerical features. Therefore, different embedding methods are used to process the different features. For example, the encoder of the autoencoder embeds the character features with truncating and padding processes. Meanwhile, the encoder embeds the numerical and categorical features separately and expands across dimensions to adapt to the same size of the character features. Further, for decoder topology, convolutional decoder networks are constructed symmetrically using convolutional layers, max-pooling layers, skip connection modules and fully connected layers.

The reconstructed unlabeled data samples are compared with the unlabeled data samples 201 to determine corresponding reconstruction losses. Since the unlabeled data samples 201 include the different types of features, different loss functions are utilized for determining reconstruction losses of the different types of features. For example, in an embodiment, a cross-entropy loss function is used for the character features and the categorical features and mean square error (MSE) loss function is used for the numerical features. Further, a total loss is calculated as a sum of all the reconstruction losses of the different the types of features multiplied by their weights. The total loss is used for back propagation and updating the autoencoder during training of the first neural network 111.

Additionally, in an embodiment, to achieve the best performance of the first neural network 111, a hyperparameter optimization framework is employed to tune hyperparameter settings (e.g., learning rate) and partial network structures (e.g., channel size of convolutional layers) in extensive trials. An objective of the hyperparameter optimization framework is to maximize testing accuracy when testing the trained first neural network 111 on new anomaly detection datasets, which helps to determine the best topology and hyperparameter settings for the autoencoder.

FIG. 2B illustrates a second training stage 200B, in accordance with an example embodiment. During the second training stage 200B, a model stacking is conducted by replacing weighted sum calculation of the total loss of the first neural network 111 with the second neural network 115. In particular, the first neural network 111 trained according to the first training stage is stacked with the second neural network 115 to take all different loss terms (i.e., the reconstruction losses of the different types of features) as inputs and predict a class of the anomaly as an output. The second neural network 115 is constructed using logistic regression (LR) network or multilayer perceptron (MLP) network. During the second training stage 200B, a combination of the first neural network 111 trained according to the first training stage 200A and the second neural network 115, is trained with labeled data samples 203 in a supervised learning manner. In such a manner, the first neural network 111 and the second neural network 115 may be jointly trained end-to-end.

During the second training stage 200B, partial networks may be freezed to achieve the best performance on testing datasets and strengthen robustness of entire model (i.e., the first neural network 111 and the second neural network 115). For instance, the encoder and the decoder of the first neural network 111 may be freezed and only the second neural network 115 is trained with the labeled data samples 203.

In an embodiment, the unlabeled data samples 201 and the labeled data samples 203 may be of same domain. Thus, the first neural network 111 and/or the second neural network 115 trained with the unlabeled data samples 201 and the labeled data samples 203 has limited generality towards new attacks and cannot adapt to new domains even with similar distributions. To that end, some embodiments aim to adopt the first neural network 111 and the second neural network 115 trained according to the second training stage to a new domain. Such a domain adaptation is achieved by executing third training stage described below in FIG. 2C.

FIG. 2C illustrates a third training stage 200C, in accordance with an example embodiment. During the third training stage 200C, the first neural network 111 and the second neural network 115 trained according to the second training stage 200B are trained with labeled samples 205 of a new domain, in a supervised learning manner. The new domain is different from the domain of the unlabeled data samples 201 and the labeled data samples 203. During the third training stage 200C, a learning rate smaller than a learning rate used in the second training stage 200B is leveraged to slightly change classification boundary of the second neural network 115 to fit new attack samples without reducing testing accuracy on previously trained datasets (i.e., the unlabeled data samples 201 and the labeled data samples 203). Such a domain adaptation is applied for multiple times to identify different but related anomalies, which has potential to detect even unseen anomalies.

In some embodiments, partial networks may be freezed during the third training stage 200C. For example, the encoder and the decoder of the first neural network 111 may be freezed and only the second neural network 115 is trained with the labeled samples 205 of the new domain. In another example, only the encoder is freezed, and the decoder and the second neural network 115 are trained with the labeled samples 205 of the new domain.

Some embodiments are based on the recognition that, in addition to detecting anomaly, it is beneficial to explain the detected anomaly, e.g., which characters/features of the input data 103 were anomalous. The explanation about the detected anomaly aids in investigating the anomaly and formulating appropriate response strategies. To that end, in some embodiments, an explainability model configured to explain the detected anomaly, is provided. In an embodiment, the explainability model is a reconstruction loss-based classifier. In another embodiment, the explainability model is an attribution-based classifier.

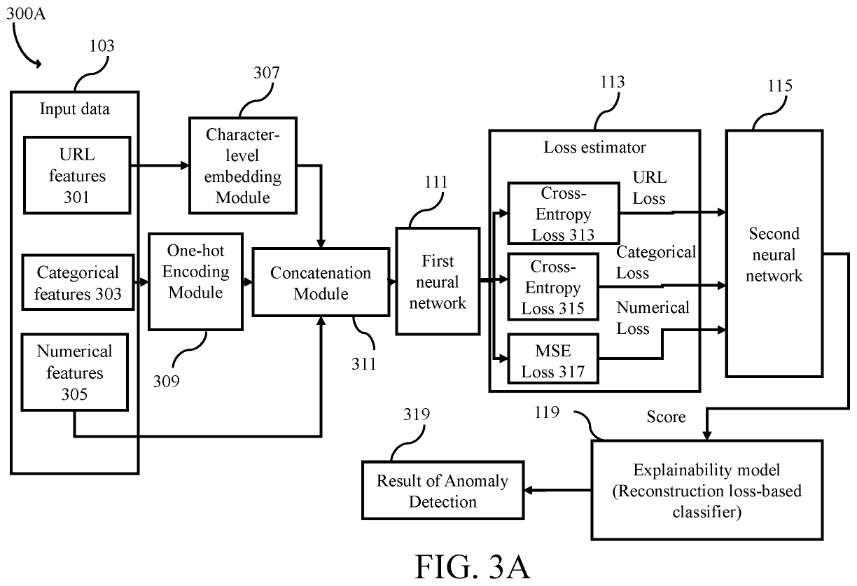

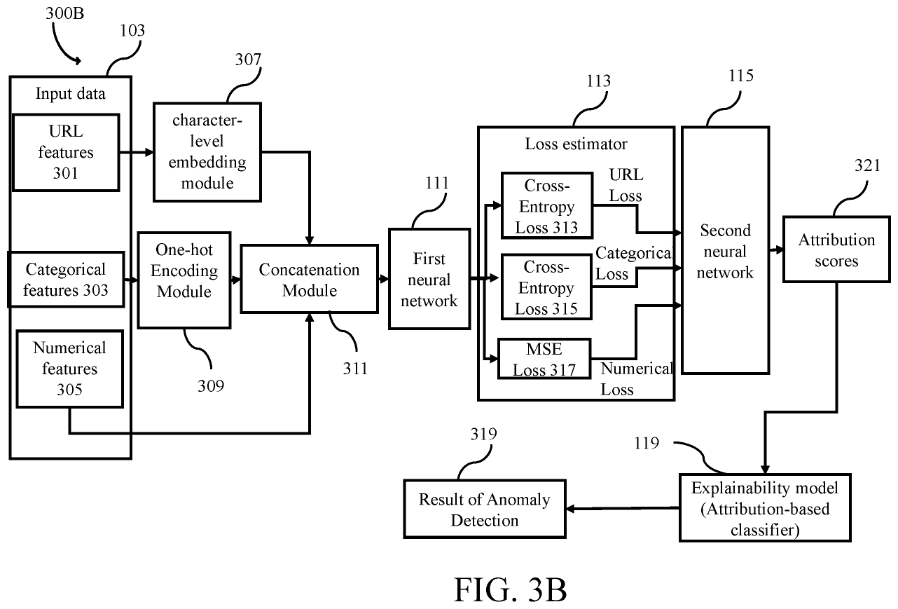

FIG. 3A illustrates an architecture of an anomalous detector 300A including a reconstruction loss-based classifier, in accordance with an example embodiment. For the purpose of explanation, the input data 103 is considered to be internet proxy log data. The anomaly detector 300A is configured for cyberattack anomaly detection on the internet proxy log data 103. The internet proxy log data is a sequential data that comprises a plurality of features such as categorical features, embedded features, and numerical features. For example, the input data 103 comprise the plurality of features as URL features 301, categorical features 303 and numerical features 305. The categorical features are those which have values from a discrete set of possibilities, where the size of the set is of manageable size.

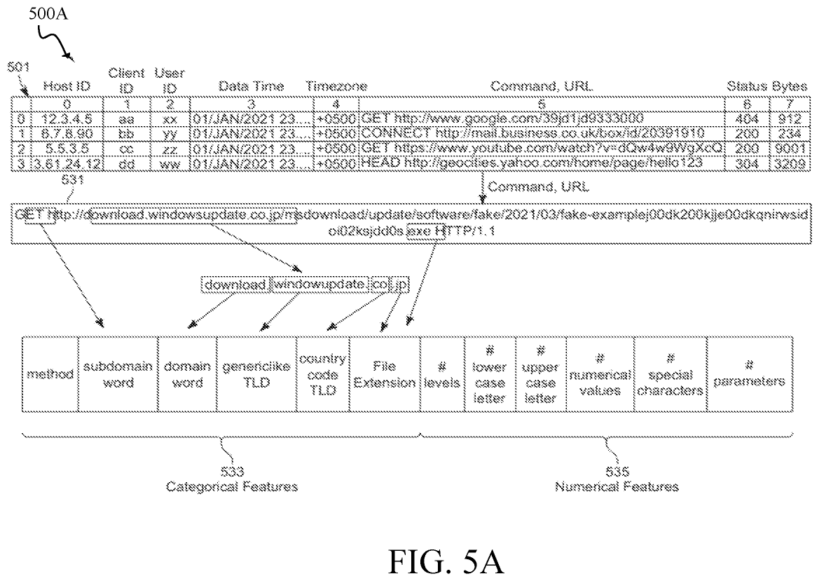

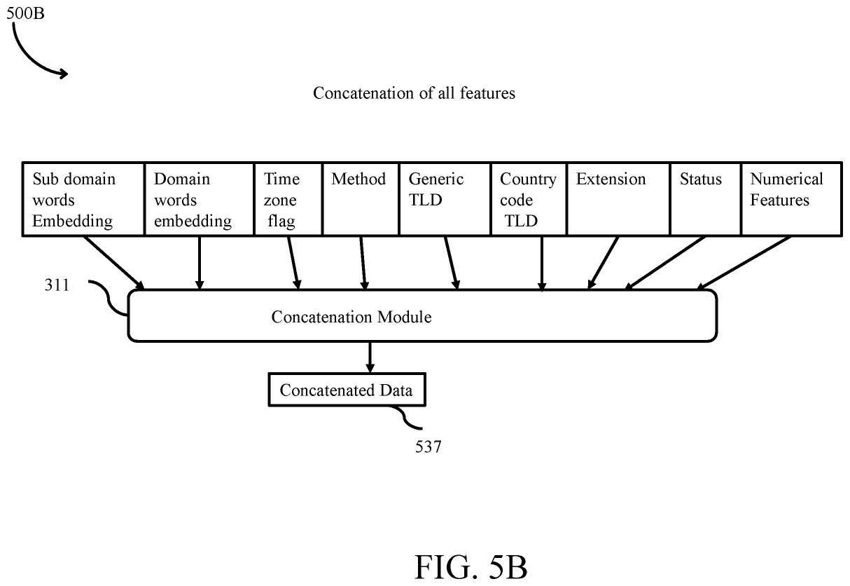

For example, in the internet proxy log data, examples of categorical features include HTTP response/error codes (which belong to a relatively small set), some top-level-domain categories, protocol categories, file extensions, etc. The embedded features are essentially categorical features, where the size of the set of possible values is far too large to be manageable. The set of possible words that can occur in domain names is an example of a categorical feature that would require embedding, which represents only a subset of the most common words. The numerical features are those which are inherently numerical, such as the size of a response, or character occurrence statistics extracted from text. Such different features present in the internet proxy log data are explained in detail in FIG. 5A.

In order to detect anomaly in the internet proxy log data, it is important to analyze the input data 103 corresponding to each feature of the plurality of features (301, 303, and 305). To achieve this, the internet proxy log data may be partitioned into a plurality of parts based on the plurality of features present in the internet proxy data.

To that end, the anomaly detector 300A accepts the input data 103 as an input and further partitions the input data 103 into the plurality of parts based on the URL features 301, the categorical features 303, and the numerical features 305.

Accordingly, a part of the input data 103 corresponding to the URL feature is provided to a character-level embedding module 307. The character-level embedding module 307 is configured to perform character or word embedding to produce a fixed dimensionality numerical vector representation. A word embedding is a learned representation for text where words or characters that have the same meaning have a similar representation. In the word embedding technique, individual words are represented as real-valued vectors in a predefined vector space. Each word is represented by a real-valued vector, often tens or hundreds of dimensions. In contrast to the word embedding, the vectorized embedded feature data from the character-level embedding module 307 is provided to a concatenation module 311.

Similarly, the part of the input data corresponding to the categorical features 303 is converted into a numerical vector via one-hot encoding module 309. The one-hot encoding module 309 is configured to execute one-hot encoding data corresponding to the categorical features 303 to transform the categorical features 303 to numerical vector representations. The one-hot encoding module 309 performs binarization of the category features 303 and includes the binarized features in the numerical vector. Thus, the numerical vector created using one-hot encoding module 309 comprises 0s and 1s. The vectorized categorical data from the one-hot encoding module 309 is provided to the concatenation module 311.

Further, the numerical features 305 are inherently numerical. In some embodiments, the numerical features may be normalized before being fed into the concatenation module 311.

The concatenation module 311 combines numerical vectors corresponding to all the features to form concatenated data. The concatenated data is provided to the first neural network 111 having the autoencoder architecture that encodes and decodes the concatenated data to reconstruct the input data 103. The reconstructed input data comprises the plurality of features i.e., the embedded features, the categorical features, and the numerical features. In order to analyze data corresponding to each feature, the reconstructed input data is provided to the loss estimator 113. The loss estimator 113 generates a URL loss, a categorical loss, and a numerical loss using a cross-entropy loss function 313, a cross-entropy loss function 315, and MSE loss function 317, respectively.

Further, the URL loss, the categorical loss, and the numerical loss are provided to the second neural network 115. Based on the URL loss, the categorical loss, and the numerical loss, the second neural network 115 determines a class level as the output. A logistic regression network or multilayer perception network is used as the second neural network 115. Based on the output of the second neural network 115, the explainability model 119 outputs a result of anomaly detection 319.

Alternatively, in some embodiments, the explainability model 119 is the attribution-based classifier. FIG. 3B illustrates an architecture of an anomalous detector 300B including the attribution-based classifier, in accordance with an example embodiment. The input data 103, the character-level embedding module 307, the one-hot encoding module 309, the concatenation module 311, the first neural network 111, and the loss estimator 113 are explained above in FIG. 3A. The second neural network 115 determines attribution scores 321. The attribution scores 321 indicate how much each character, categorical feature, and numerical feature of the internet proxy log data (i.e., the input data 103) can be identified as an anomaly sample. Further, the attribution scores 321 are input to the explainability model 119, which is the attribution-based classifier. Based on the attribution scores 321, the explainability model 119 interprets the anomaly detected by the anomaly detector to output the result of anomaly detection 319 including a class of the detected anomaly.

In some embodiments, the explainability model 119 utilizes Integrated gradients (IG) approach for determining type of attacks. IG represent integral of gradients with respect to inputs along a path from a given baseline to the input. Generally, IG provides good sensitivity to trace different predictions for every input and baseline. In addition, the IG approach satisfies implementation invariance, which means that attribution may be colloquially defined and accumulated for output to the plurality of features. IS score is accompanying with the trace, from the baseline to input

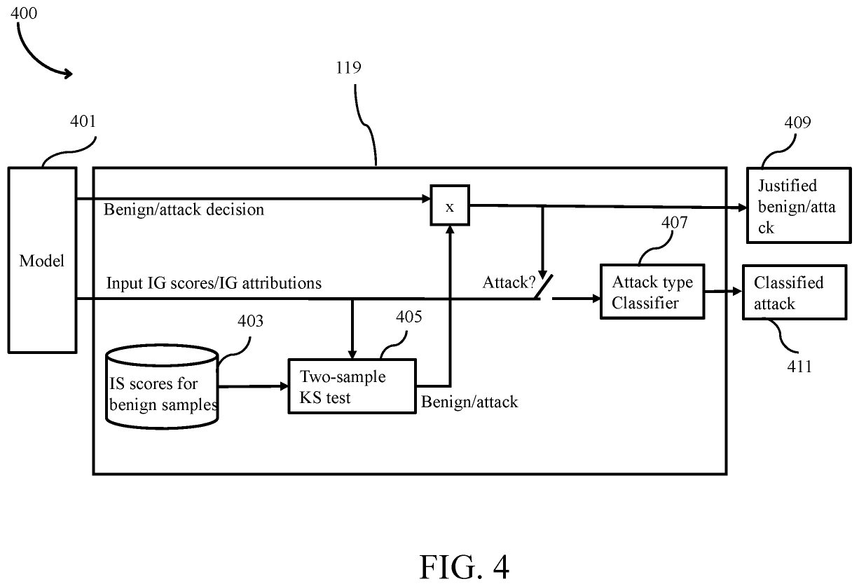

FIG. 4 illustrates an architecture 400 of the explainability model 119 of the anomaly detector 101, in accordance with an example embodiment. A model 401 is a combination of the first neural network 111, the loss estimator 113 and the second neural network 115 (as explained above in FIG. 1B). The model 401 outputs benign/attack decision and attribution/IG scores, which are further inputted to the explainability model 119. The explainability model 119 uses IS scores for benign samples 403, a two-sample Kolmogorov-Smirnov (KS) KS test 405, and an attack type classifier 407 to determine justified benign/attack 409 and/or classified attack 411. To distinguish between an attack and benign samples, a two-sample KS test 405 is executed. The two-sample KS test 405 uses cumulative distribution functions (CDFs) for the attack and a set of historical benign samples. The two-sample KS test 405 provides a further decision for the benign/attack decision 409. When the justified benign/attack 409 and the two-sample KS test 405 both provide an anomaly (attack) decision, the attack type classifier 407 classifies the attack to output a classified attack 411.

The IG approach is implemented by the anomaly detector 101 where the model 401 assigns the attribution scores for each input feature to identify those significant ones associated with anomaly samples. In an example, for a single anomaly sample, IG approach may identify the anomaly indicatives from the characters of its URL, the categorical features, and the numerical features. Since a length of URL varies for a group of samples, IG approach alternatively identifies the anomaly indicatives at the encoding vector level, which is fixed length by encoding the characters of original URL for each sample into a compressed vector representation.

In some other embodiments, the explainability model 119 utilizes correlation heatmap that is a graphic representation of a 2D correlation matrix, using colored cells to represent correlation between different variables. For the IG scores, row and column of a correlation matrix are attributions for the plurality of features, and a value of each element in the correlation matrix represents the dependence, also termed as correlation, between two corresponding row and column features. The values of elements in the correlation matrix, also known as correlation coefficients, are visualized as colored cells, conducting a heatmap to show a relationship of predictive dependence. As one example, a green cell means positive correlation and a red cell means negative correlation. Darker the color of a cell is, the stronger correlation the two features have. The correlation heatmap visualizes statistical measurements of correlation among different features as a graphic representation, directly showing their dependences with respect to IG scores.

Some embodiments are based on the recognition that it is difficult to group all the plurality of features by the correlation coefficients when trying to check the numerical features e.g., identify the top five positive and negative correlations. To mitigate such a problem, clustering of correlation heatmap is introduced, i.e., congregate correlation coefficients into close groups. Pair-wise positive and negative correlation information is used to determine an optimal number of cluster and rearrange row and column features in the correlation heatmap. Each cluster of this new correlation heatmap shows a group of features that all have closely positive or negative correlation, which indicates their strong dependence when predicting a data sample. Using correlation clustering of IG attributions or scores the explainability model 119 generates different heatmaps as unique fingerprints for different types of attacks.

FIG. 5A illustrates a schematic 500A for decomposition of the internet proxy log data into categorical features and numerical features, in accordance with an example embodiment. The internet proxy log data 501 comprises information associated with requests made by a user to a network. For example, the internet proxy log data 501 comprises host id, client id, and user id of the user that has requested the network to access a specific website or web content. The internet proxy log data 501 further comprises data time, time-zone, and command used by the user to access the specific website or the web content along with information about status of the command and number of bytes used by the command.

The internet proxy log data 501 is a raw data that comprises sequences of log entries of internet traffic requests from many different users, where these sequences of log entries are inherently interleaved in the internet proxy log data 501. Thus, in order to detect anomaly in the internet proxy log data 501, the anomaly detector 101 first de-interleaves the sequences of log entries generated by different users, and then handles each user's sequence independently. Further, the alternative of simply processing all of the sequences while interleaved may overburden training of the first neural network 111 with additional unnecessary complexity.

A Uniform Resource Locator (URL) 531 corresponding to one of the de-interleaved sequences may be obtained by the anomaly detector 101, where the anomaly detector 101 decomposes the URL 531 into a plurality of parts based on the plurality of features comprised in the URL 531. The URL 531 comprises different information associated with the request made by the user to access the website or the web content. The information comprised by the URL 531 is decomposed into the categorical features 533 and the numerical features 535. The information decomposed into the categorical feature 533 comprises method name used by the user to access the website, in this case method name corresponds to “GET”, where GET is a default HTTP method that is used to retrieve resources from a particular URL. The information comprised in the categorical features 533 further includes sub-domain words, in this case “download”; domain words, in this case “windowsupdate.”; generic-like top-level domain (TLD): “co.”; country code TLD: “jp”; and file extension: “.exe”. The subdomain word and domain word may be further categorized into embedded features due to the very large word vocabulary sizes.

Further, information of the URL 531 categorized into numerical features 535 comprises number (#) of levels, # of lowercase letters, # of uppercase letters, # of numerical values, # of special characters, and # of parameters. The data corresponding to each feature is vectorized. The vectorized data corresponding to the categorical features 533 and the numerical features 535 is provided to the concatenation module 311.

FIG. 5B illustrates a block diagram 500B of the concatenation module 311 for concatenation of the vectorized data corresponding to all the categorical features 533 and the numerical features 535, according to some embodiments of the present disclosure. The concatenation module 311 concatenates the vectorized data corresponding to all the categorical features 533 and the numerical features 535 and generates concatenated data 537.

In order to vectorize data (text) in the domain and sub-domain words, the character-level embedding module 307 is trained, where training data that comprises words form a vocabulary of the most commonly seen words is used. Words outside of the most common set may be labeled as an “other” group in the training of the character-level embedding module 307. However, the necessary vocabulary can still be very large making it difficult to handle the size of the vocabulary. Thus, to handle the size of the vocabulary during training, the word embedding module may be pre-trained for each feature of the plurality of features present in the URL 531, to convert each word, in domain words and sub-domain words, to a smaller dimensional feature vector rather than to use a very large one-hot categorical encoding. Thus, these embedding vectors (i.e., feature vectors) are used in place of original domain/sub-domain words as processed features for the first neural network 111 to work with.

The concatenated data 537 is provided to the first neural network 111, where the autoencoder uses the encoder to encode the concatenated data 537 into a latent space representation. The autoencoder architecture further uses the decoder to reconstruct concatenated data 537 (i.e., vectorized URL 531) from the latent space representation of the concatenated data 537. Further, the reconstructed concatenated data 537 is processed with the loss estimator 113, the second neural network 115, and the explainability model 119 to produce the result of anomaly detection 313, as explained above in FIG. 3A.

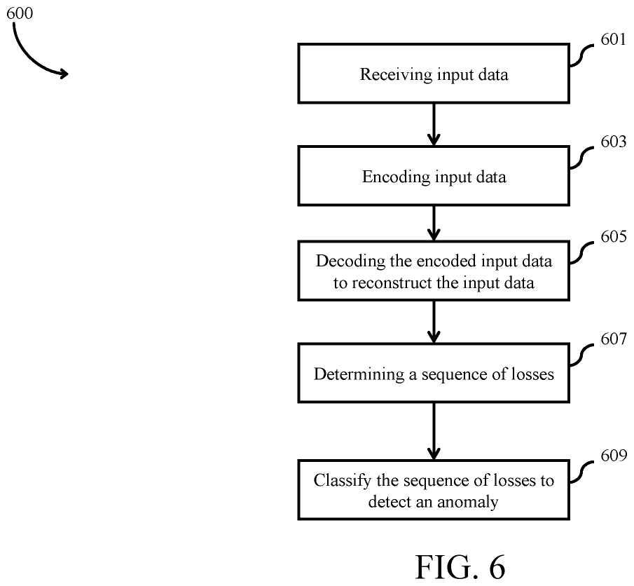

FIG. 6 illustrates a flowchart of a method 600 for detecting anomaly, in accordance with an example embodiment. The method 600 starts at step 601, where input data (e.g., the input data 103) in which anomaly is to be detected may be received by an anomaly detector (e.g., the anomaly detector 101). The input data may correspond to sequential data that comprises mixture of heterogeneous features. The sequential data may include text data (such as internet proxy log data), image data, video data, audio data, protein sequences, or the likes. In some embodiments, the input data may comprise multiple features such as categorical features, numerical features, or the likes.

Further, at step 603 the input data may be provided to a first neural network (e.g., first neural network 111 having autoencoder architecture) of the anomaly detector, where the input data may be encoded by an encoder neural network comprised by the autoencoder architecture. The input data may be compressed by the encoder and further encoded into a latent space representation.

At step 605, the encoded input data may be reconstructed using a decoder neural network of the autoencoder architecture of the first neural network. The decoder may use the latent space representation of the input data to reconstruct the input data.

At step 607, a sequence of losses is determined by comparing a plurality of parts of the input data with corresponding plurality of parts of the reconstructed input data. At step 609, the sequence of losses is classified, based on a second neural network (e.g., first neural network 115) trained in a supervised manner, to detect an anomaly to produce a result of anomaly detection. The result of anomaly detection includes one or a combination of a type of the anomaly and a severity of the anomaly.

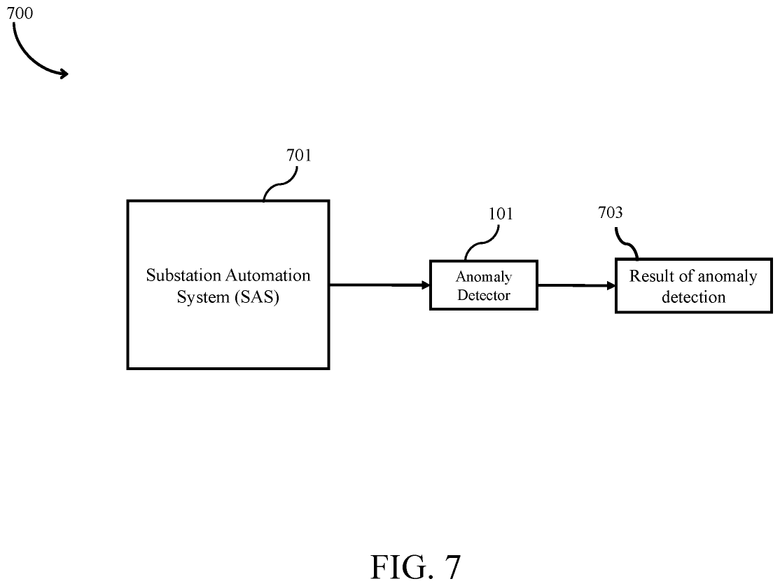

According to some embodiments, the anomaly detector 101 may be used to detect cyberattacks on a Substation Automation System (SAS) in a power grid. The SAS uses IEC 61850 based protocols, for example, Goose, SMV, and MMS. The cyberattacks on the SAS are possible via IEC 61850 since it uses Ethernet-based communication that does not support encryption in field devices at substations. For example, Generic Object Oriented Substation Event (GOOSE) message is used to send a trip signal to a circuit breaker of the substations. However, cyber-attackers can spoof and monitor MMS packets that include vital information, such as TCP flags session (e.g., port number, sequence number, Ack number), IP address, and MMS field information (e.g. itemID, read/write status, etc.). The SAS may gather information about such events as event log data that includes log entries. The log entries include categorical, numerical, and character features, describing vital information about data packets and/or other system-level events. The anomaly detector 101 may be used to detect the cyberattacks on the SAS, as described below with respect to FIG. 7.

FIG. 7 illustrates a block diagram 700 for detecting cyberattack on a SAS 701, in accordance with an example embodiment. The substation 701 is communicatively coupled to the anomaly detector 101. Data corresponding to SAS 701 operation is input to the anomaly detector 101. For example, the event log data gathered by SAS 701 is input to the anomaly detector 101. The anomaly detector 101 processes the input data, as described above in FIG. 1B, to produce a result of anomaly detection 703 including one or combination of a type of cyberattack and a severity of cyberattack on the SAS 701.

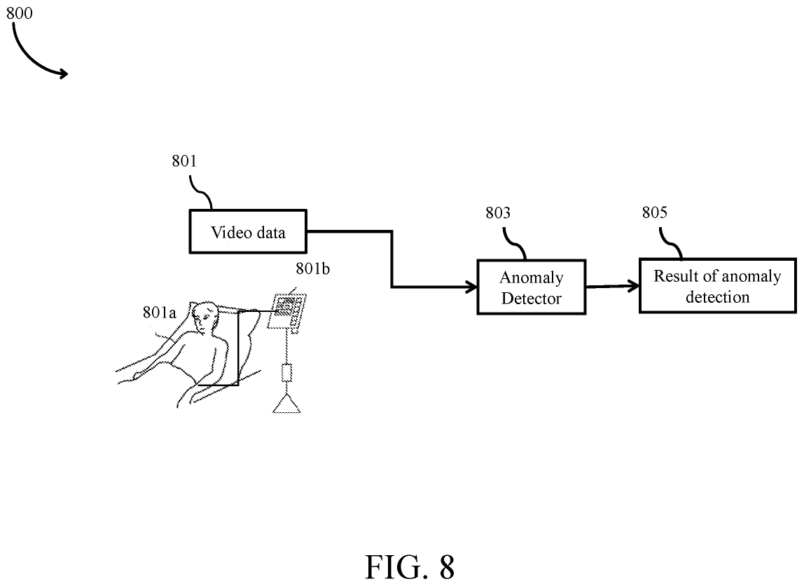

FIG. 8 illustrates a block diagram 800 for anomaly detection in video data 801, in accordance with an example embodiment. The video data 801, a form of sequential data, may be real-time video and/or recorded video. In the FIG. 8, the video data 801 is of a patient 801a lying in a bed, where heartbeat of the patient 801a is being monitored using an electrocardiogram (ECG) machine 801b. The video data 801 is provided to an anomaly detector 803. The anomaly detector 803 may correspond to the anomaly detector 101. On receiving the video data 801, the anomaly detector 803 may process the video data 801. Each image frame of the video data 801 comprises different features, for example, different color channels like green, red, blue, or the likes. The different features of the video data 801 may comprise preprocessed motion vectors in addition to raw images. Further, each image frame is processed by the anomaly detector 803 using a variety of tools, like object detection, skeleton tracking, and the likes that yields a plurality of features in the video data 801 in addition to the raw pixel values.

For example, by using object detection tools, the anomaly detector 803 can detect the ECG machine 801b in image frames and zoom in or zoom out on the ECG machine 801b in the image frames. Further, an image of an ECG graph on the ECG machine 801b may be analyzed to detect anomaly in heartbeat of the patient 801a. The anomaly detector 803 may determine a sequence of losses corresponding to the images of the ECG graph on the ECG machine 801b comprised in one or more image frames of the video data 801. The anomaly detector 803 uses the sequence of losses to determine a result of anomaly detection 805 including a type of anomaly and/or a severity of anomaly in the heartbeat of the patient 801a.

In another embodiment, the anomaly detector 803 may be used to detect anomaly in a pose (or posture) of the patient 801a. For example, the patient 801a may be in abnormal pose when the patient 801a is about to fall from the bed. Further, the abnormal pose of the patient 801a may be due to seizure attack. Based on the video data 801, the anomaly detector 803 may determine a plurality of features associated with movement of the patient 801a from various image frames of the video data 801. Further, skeleton tracking tools may be used by the anomaly detector 803 to detect anomaly in position (or pose or posture) of the patient 801a. Also, the anomaly detector 803 may then determine a type anomaly in the position of the patient 801a.

### Exemplar Implementation

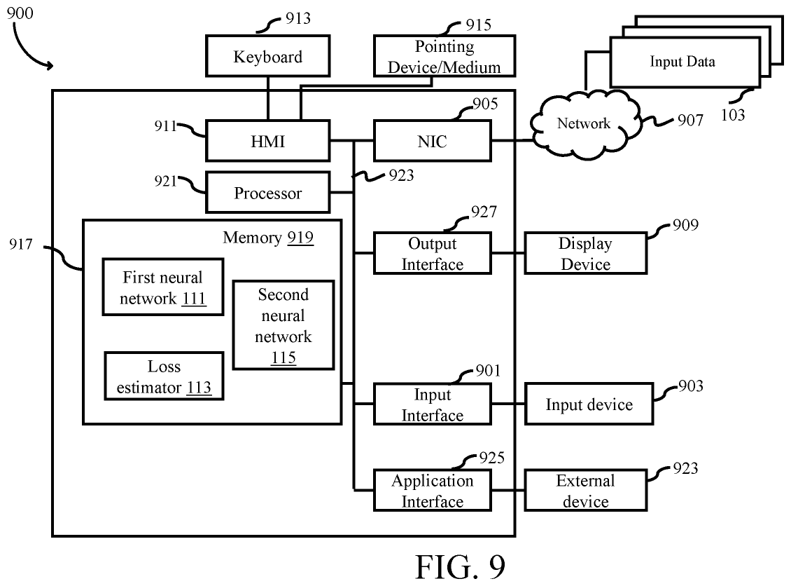

FIG. 9 illustrates a block diagram of a computer-based anomaly detector 900 for detecting anomaly from the input data, in accordance with an example embodiment. The computer-based anomaly detector 900 includes a number of interfaces connecting the anomaly detector 900 with other systems and devices. The anomaly detector 900 includes an input interface 901 configured to accept the input data 103, where the input data 103 comprises sequential data such as internet proxy data, video data, audio data, image data, or the likes.

In some embodiments, the anomaly detector 900 includes a network interface controller (NIC) 905 configured to obtain the input data 103, via network 907, which can be one or combination of wired and wireless network.

The network interface controller (NIC) 905 is adapted to connect the anomaly detector 900 through a bus 923 to the network 907 connecting the anomaly detector 900 with an input device 903. The input device 903 may correspond to a proxy log data recorder that records proxy log data to be provided to the anomaly detector 900 to detect anomaly in the recorded proxy log data. In another embodiment, the input device 903 may correspond to video recorder, where the video recorder may record video to be provided to the anomaly detector 900 to detect anomaly in the recorded video data.

Additionally, or alternatively, the anomaly detector 900 can include a human machine interface (HMI) 911. The human machine interface 911 within the anomaly detector 900 connects the anomaly detector 900 to a keyboard 913 and pointing device 915, where the pointing device 915 may include a mouse, trackball, touchpad, joystick, pointing stick, stylus, or touchscreen, among others.

The anomaly detector 900 includes a processor 921 configured to execute stored instructions 917, as well as a memory 919 that stores instructions that are executable by the processor 921. The processor 921 can be a single core processor, a multi-core processor, a computing cluster, or any number of other configurations. The memory 919 can include random access memory (RAM), read only memory (ROM), flash memory, or any other suitable memory systems. The processor 921 may be connected through the bus 923 to one or more input and output devices.

The instructions 917 may implement a method for detecting anomaly, according to some embodiments. To that end, computer memory 919 stores the first neural network 111, the loss estimator 113, and the second neural network 115.

The first neural network 111 has an autoencoder architecture that includes an encoder trained to encode the input data and a decoder trained to decode the encoded input data to reconstruct the input data. The loss estimator 113 compares a plurality of parts of the input data with corresponding plurality of parts of the reconstructed input data to determine a sequence of losses for different components of a reconstruction error. The second neural network 115 is trained in a supervised manner to classify the sequence of losses to detect an anomaly to produce a result of anomaly detection including one or a combination of a type of the anomaly and a severity of the anomaly;

In some embodiments, an output interface 927 may be configured to render the result of anomaly detection on a display device 909. Examples of a display device 909 include a computer monitor, television, projector, or mobile device, among others. The computer-based anomaly detector 900 can also be connected to an application interface 925 adapted to connect the computer-based anomaly detector 900 to an external device 923 for performing various tasks.

### Embodiments

The description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Further, embodiments of the present disclosure and the functional operations described in this specification can be implemented in digital electronic circuitry, in tangibly embodied computer software or firmware, in computer hardware, including the structures disclosed in this specification and their structural equivalents, or in combinations of one or more of them.

Further some embodiments of the present disclosure can be implemented as one or more computer programs, i.e., one or more modules of computer program instructions encoded on a tangible non transitory program carrier for execution by, or to control the operation of, data processing apparatus. Further still, program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code.

A computer program can be deployed to be executed on one computer or on multiple computers that are located at one site or distributed across multiple sites and interconnected by a communication network. Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data.

Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

1. An anomaly detector, comprising:
at least one processor; and
a memory having instructions stored thereon that form modules of the anomaly detector, wherein the at least one processor is configured to execute the instructions of the modules of the anomaly detector, the modules comprising:
an input interface configured to accept input data;
a first neural network having an autoencoder architecture including an encoder trained to encode the input data and a decoder trained to decode the encoded input data to reconstruct the input data;
a loss estimator configured to compare a plurality of parts of the input data with corresponding plurality of parts of the reconstructed input data to determine a sequence of losses for different components of a reconstruction error;
a second neural network trained in a supervised manner to classify the sequence of losses to detect an anomaly to produce a result of anomaly detection including one or a combination of a type of the anomaly and a severity of the anomaly; and
an output interface to render the result of anomaly detection.

2. The anomaly detector of claim 1, wherein the second neural network is a deep neural network.

3. The anomaly detector of claim 1, wherein the first neural network and the second neural network are jointly trained.

4. The anomaly detector of claim 1, wherein the first neural network and the second neural network are jointly trained end-to-end.

5. The anomaly detector of claim 1, wherein, during a first training stage, the first neural network is trained with unlabeled data samples in an unsupervised learning manner.

6. The anomaly detector of claim 5, wherein, during a second training stage, the first neural network trained with the unlabeled data samples and the second neural network are trained with labeled data samples in a supervised learning manner.

7. The anomaly detector of claim 6, wherein, during the second training stage, the second neural network is trained with the labeled data samples in the supervised learning manner.

8. The anomaly detector of claim 7, wherein, during a third training stage, the first neural network and the second neural network trained in the second training stage are trained with labeled samples.

9. The anomaly detector of claim 8, wherein, during the third training stage, the second neural network trained in the second training stage is trained with the labeled samples.

10. The anomaly detector of claim 9, wherein a domain of the labeled samples is different from a domain of the unlabeled data samples and the unlabeled data samples.

11. The anomaly detector of claim 1, the modules further comprising an explainability module configured to predict a class of anomaly.

12. The anomaly detector of claim 11, wherein the explainability model corresponds to an attribution based classifier configured to determine a class of anomaly based on attribution scores corresponding to the input data.

13. The anomaly detector of claim 12, wherein the second neural network is configured to determine the attribution scores corresponding to the input data.

14. The anomaly detector of claim 1, wherein the input data corresponds one of internet proxy log data, image data, video data, or audio data.

15. A method for anomaly detection, wherein the method uses a processor coupled with stored instructions implementing the method, wherein the instructions, when executed by the processor carry out steps of the method, comprising:
receiving input data;
encoding the input data and decoding the encoded data to reconstruct the input data, based on a first neural network having an autoencoder architecture;
determining a sequence of losses by comparing a plurality of parts of the input data with corresponding plurality of parts of the reconstructed input data;
classifying, based on a second neural network trained in a supervised manner, the sequence of losses to detect an anomaly to produce a result of anomaly detection including one or a combination of a type of the anomaly and a severity of the anomaly; and
rendering the result of anomaly detection.

16. The method of claim 15, wherein the input data corresponds to internet proxy log data, image data, video data, and audio data.

17. The method of claim 15, wherein the second neural network is a deep neural network.

18. The anomaly detector of claim 15, wherein the first neural network and the second neural network are jointly trained.

19. The anomaly detector of claim 15, wherein the first neural network and the second neural network are jointly trained end-to-end.

20. A non-transitory computer readable storage medium embodied thereon a program executable by a processor for performing a method, the method comprising:
receiving input data;
encoding the input data and decoding the encoded data to reconstruct the input data, based on a first neural network having an autoencoder architecture;
determining a sequence of losses by comparing a plurality of parts of the input data with corresponding plurality of parts of the reconstructed input data;
classifying, based on a second neural network trained in a supervised manner, the sequence of losses to detect an anomaly to produce a result of anomaly detection including one or a combination of a type of the anomaly and a severity of the anomaly; and
rendering the result of anomaly detection.
